(19) United States
(12) Patent Application Publication
(10) Pub. No.: US 2018/0317368 A1
(43) Pub. Date: Nov. 8, 2018

(54) Self-Moving Device and Control Method for Self-Moving Device

(71) Applicant: Positec Power Tools (Suzhou) Co., Ltd., Suzhou (CN)

(72) Inventors: Jiang Du, Suzhou (CN); Zhendong Gao, Suzhou (CN)

(21) Appl. No.: 16/040,041

(22) Filed: Jul. 19, 2018

Related U.S. Application Data
(63) Continuation of application No. PCT/CN2017/072098, filed on Jan. 22, 2017.

(30) Foreign Application Priority Data
Jan. 21, 2016 (CN) 201610039085.3
Jul. 19, 2016 (CN) 201610569231.3
Nov. 11, 2016 (CN) 201610997080.1

(51) Int. Cl. A01B 39/18; A01B 39/28; A01B 49/02; A01B 39/08

(52) U.S. Cl. CPC A01B 39/18; A01B 39/28; A01B 39/22; A01B 39/085; A01B 49/022

(57) ABSTRACT

A self-moving device and a control method for a self-moving device are disclosed. The self-moving device includes a moving module, a control module and an adjusting device. The moving module includes a track, driven by a drive motor to drive the self-moving device to move. The control module controls the adjusting device to adjust a grounding length of the track, such that the grounding length of the track when the self-moving device turns is smaller than that of the track when the self-moving device moves straightly. The control method for a self-moving device includes the steps: controlling to reduce the grounding length of the track before the self-moving device is controlled to turn; and controlling to increase the grounding length of the track after the self-moving device is controlled to finish the turning.

### BACKGROUND

### Technical Field

The present invention relates to the technical field of power tools, and in particular to a self-moving device and a control method for a self-moving device.

### Related Art

The mower adopts a track as a walking mechanism, and the track type walking mechanism comprises a drive wheel, a guide wheel and a track coating the drive wheel and the guide wheel. Usually, the track between the drive wheel and the guide wheel of such track type walking mechanism is grounded.

### SUMMARY

It is necessary to provide a self-moving device, which has smaller damage to the lawn during turning and better trafficability.

It is further necessary to provide a control method for a self-moving device.

A self-moving device, comprising: a housing; and a moving module, mounted in the housing, wherein the moving module comprises a track, driven by a drive motor to drive the self-moving device to move; the self-moving device is characterized in that the self-moving device further comprises a control module and an adjusting device, the control module controls the adjusting device to adjust a grounding length of the track, such that the grounding length of the track when the self-moving device turns is smaller than that of the track when the self-moving device moves straightly.

In the present self-moving device, since the grounding length of a track is smaller during turning, the contact area between the track and a lawn is smaller, the damage to the lawn can be reduced, the minimal turning radius of the self-moving device can be further reduced, the trafficability of the machine is improved, and meanwhile, the drive force of a motor can be reduced.

In one embodiment, the track comprises a grounding side and a remote side opposite to the grounding side, and a thrust wheel can move between the grounding side and the remote side, such that the track type automatic walking device can be in a first working state and a second working state respectively.

In one embodiment, the control module controls the grounding length of the track to be larger than or equal to 300 mm when the self-moving device moves straightly.

In one embodiment, the control module controls the grounding length of the track to be smaller than 300 mm when the self-moving device turns.

In one embodiment, a turning radius when the control module controls the moving module to drive the self-moving device to turn is smaller than or equal to 0.5 m.

In one embodiment, the turning radius when the control module controls the moving module to drive the self-moving device to turn is zero.

In one embodiment, the moving module comprises a wheel set, the track winds the wheel set, the wheel set comprises a front wheel and a back wheel, and the grounding length of the track is the distance between the front wheel and the back wheel in a horizontal direction; and the adjusting device comprises a horizontal adjusting mechanism, adjusting the distance between the front wheel and the back wheel in the horizontal direction.

In one embodiment, the moving module comprises a wheel set, the track winds the wheel set, the wheel set comprises a front wheel and a back wheel, the adjusting device comprises a thrust wheel, and the thrust wheel is located between the front wheel and the back wheel.

In one embodiment, the track coats the thrust wheel.

In one embodiment, the grounding length of the track is smaller than or equal to a distance between the thrust wheel and the front wheel, or smaller than or equal to a distance between the thrust wheel and the back wheel when the self-moving device turns.

In one embodiment, the grounding length of the track is the distance between the front wheel and the back wheel in the horizontal direction when the self-moving device straightly moves.

In one embodiment, the adjusting device comprises a lifting mechanism, connected to the thrust wheel, the lifting mechanism drives the thrust wheel to descend, to reduce the grounding length of the track; and the lifting mechanism drives the thrust wheel to ascend, to increase the grounding length of the track.

In one embodiment, the control module controls the lifting mechanism to drive the thrust wheel to descend before controlling the self-moving device to turn; and the control module controls the lifting mechanism to drive the thrust wheel to ascend after controlling the self-moving device to finish the turning.

In one embodiment, a distance between the center of gravity of the self-moving device and the center of the thrust wheel along a moving direction of the self-moving device is smaller than or equal to 100 mm.

In one embodiment, the distance between the center of gravity of the self-moving device and the center of the thrust wheel along the moving direction of the self-moving device is 0.

In one embodiment, the self-moving device is an autonomous mower.

In one embodiment, the adjusting device comprises a turning wheel, liftably assembled on the bottom of the housing, the turning wheel has a first position and a second position in a height direction of the housing, wherein in the first position, the bottom of the turning wheel is higher than the bottom of the track, and in the second position, one end of the track is lifted up relative to the other end of the track by the turning wheel; and when the self-moving device turns, the control module controls the turning wheel to be in the second position, and when the self-moving device moves straightly, the control module controls the turning wheel to be in the first position.

According to the self-moving device, the bottom of a housing is provided with a turning wheel, and the turning wheel is controlled to descend before the self-moving device turns, such that one end of the track is lifted away from the ground, the turning wheel is used for auxiliary support, and then the turning is performed to reduce a grounding area of the track, thereby reducing the damage of the track to a turf during turning.

In one embodiment, the housing comprises a front part and a back part along a moving direction of the self-moving device, and a turning wheel set is assembled on the front part of the housing.

In one embodiment, a control module comprises a border detection sensor mounted on the housing, configured to monitor the position information between the self-moving device and a border, and the control module controls the turning wheel to move to a second position from a first position according to received position information.

In one embodiment, the border detection sensor is a distance sensor, when the border detection sensor detects that the distance between the self-moving device and the border reaches a predetermined standard, the control module controls the turning wheel to move to the second position, and controls the drive motor to drive the moving module to cause the self-moving device to turn.

In one embodiment, the border detection sensor is a collision type detection switch, when the border detection sensor touches the border, and the control module controls the turning wheel to move to the second position, and controls the drive motor to drive the moving module to cause the self-moving device to turn.

In one embodiment, the border is an electronic boundary, the border detection sensor is one or more position sensors, when any position sensor spans across the border, the control module controls the turning wheel to move to the second position, and controls the drive motor to drive the moving module to cause the self-moving device to turn.

In one embodiment, before the control module controls the drive motor to drive the moving module to cause the self-moving device to turn, the drive motor is caused to drive the moving module to withdraw.

In one embodiment, the border is an obstacle or electronic boundary.

In one embodiment, the drive motor driving the moving module to cause the self-moving device to turn comprises that the drive motor causes the track on both sides of the housing to realize differential motion.

In one embodiment, the moving module further comprises a guide wheel and a drive wheel, the track on both sides of the housing is correspondingly provided with the guide wheel and the drive wheel, a pair of the drive motors is disposed and respectively configured to drive the drive wheels on both sides of the housing, or one drive motor is disposed, and a differential mechanism is disposed between the drive motor and the drive wheels on both sides.

In one embodiment, the control module comprises a signal receiver receiving an outside turning instruction, after the signal receiver receives the turning instruction, the control module controls the turning wheel to move to the second position, and controls the drive motor to drive the moving module to cause the self-moving device to turn.

In one embodiment, the signal receiver is a wireless or wired signal receiver; or the signal receiver is a trigger switch, and when the trigger switch is triggered, the control module controls the turning wheel to move to the second position, and controls the drive motor to drive the moving module to cause the self-moving device to turn.

In one embodiment, the housing has a front end and a back end which are opposite, an advancing direction when the self-moving device works is consistent with the direction from the back end to the front end, and the turning wheel is eccentrically disposed on the bottom of the housing, and deviated toward the front end.

In one embodiment, one or more turning wheels are disposed, to provide one or more support points when in the second position.

In one embodiment, an adjusting device comprises a support structure, mounted in the housing; the control module controls the support structure to extend out from the bottom of the housing or withdraw into the housing; before controlling the self-moving device to turn, the control module controls the support structure to extend out from the bottom of the housing, to support at least part of the track away from a working plane; and after controlling the self-moving device to finish the turning, the control module controls the support structure to withdraw into the housing.

The self-moving device is simple and reasonable in structural design, before the self-moving device turns, the support structure can extend out of the housing to support the self-moving device away from the lawn, and the contact friction between the track and the lawn can be reduced, to further reduce the abrasion of the track to the lawn. After the turning is finished, the support structure is withdrawn into the housing, the self-moving device then continues to operate, the work capacity of the self-moving device is not affected, the working effect of the self-moving device is ensured, and the use is convenient.

In one embodiment, when the support structure extends out from the bottom of the housing, the grounding length of the track is zero.

In one embodiment, the self-moving device comprises a turning mechanism, rotatably connected to the housing and the support structure, when the support structure extends from the bottom of the housing, the control module controls the turning mechanism to drive the housing to rotate around the support structure, to cause the self-moving device to turn.

In one embodiment, the support structure is located on the center of gravity of the self-moving device.

In one embodiment, the adjusting device further comprises a drive structure, mounted in the housing; the control module is connected to the support structure by the drive structure, and the control module controls the drive structure to drive the support structure to extend out or withdraw.

In one embodiment, the self-moving device further comprises a height sensor, and the height sensor is electrically connected to the control module; and the control module can control the height sensor to detect the height of a trimmed object in the lawn, to control an extending length of the support structure.

In one embodiment, the extending length of the support structure is larger than or equal to the height of the trimmed object.

In one embodiment, the support structure is withdrawn into the housing, and the end part of the support structure is flush with the bottom of the housing.

In one embodiment, the support structure comprises a support rod, and the control module can control the support rod to extend out relative to the housing or withdraw into the housing.

In one embodiment, the amount of the support rods is two, and the sectional sizes of the at least two support rods are changed in sequence; the axes of the at least two support rods are coincided and disposed by sleeving; and the control module controls the at least two support rods to extend out in sequence or withdraw in sequence.

In one embodiment, the support structure further comprises a support chassis, and the chassis is disposed on end of the support rod away from the housing; and the support rod makes contact with the lawn by the chassis.

In one embodiment, a sectional area of the chassis is 1.2-5 times of a sectional area of the support rod.

In one embodiment, the support structure is a cylinder, the cylinder comprises a cylinder block and a telescopic rod extending out or withdrawing relative to the cylinder block; and the cylinder block is mounted in the housing and the telescopic rod can extend out or withdraw relative to the housing.

According to the control method for a self-moving device, the self-moving device comprises a housing; and a moving module, mounted in the housing; the moving module comprises a track, driven by a drive motor to drive the self-moving device to move; the control method for a self-moving device comprises the steps: controlling to reduce a grounding length of the track before the self-moving device is controlled to turn; and controlling to increase a grounding length of the track after the self-moving device is controlled to finish the turning.

In one embodiment, the self-moving device comprises a wheel set, the track winds the wheel set, the wheel set comprises a front wheel and a back wheel, the self-moving device further comprises a thrust wheel, and the thrust wheel is located between the front wheel and the back wheel; the control method for a self-moving device comprises the steps: controlling the thrust wheel to descend to reduce the grounding length of the track before the self-moving device is controlled to turn; and controlling the thrust wheel to ascend to increase the grounding length of the track after the self-moving device is controlled to finish the turning.

In one embodiment, the self-moving device comprises a wheel set, the track winds the wheel set, the wheel set comprises a front wheel and a back wheel, and the grounding length of the track is the distance between the front wheel and the back wheel in a horizontal direction; the control method for a self-moving device comprises the steps: controlling to reduce the distance between the front wheel and the back wheel in the horizontal direction before the self-moving device is controlled to turn; and controlling to increase the distance between the front wheel and the back wheel in the horizontal direction after the self-moving device is controlled to finish the turning.

In one embodiment, the self-moving device comprises a turning wheel, liftably assembled on the bottom of the housing; and the control method for a self-moving device comprises the steps: controlling the turning wheel to descend to cause one end of the track to be lifted up relative to the other end of the track before the self-moving device is controlled to turn; and controlling the turning wheel to ascend to cause the bottom of the turning wheel to be higher than the bottom of the track after the self-moving device is controlled to finish the turning.

In one embodiment, the control module receives a turning instruction or turning information according with a preset standard, and controls the turning wheel to move to a second position from a first position, such that one end of the track is lifted up relative to the other end of the track; and the control module controls the drive motor to drive the moving module to cause the self-moving device to turn.

In one embodiment, after the turning is finished, the control module controls the turning wheel to return back to the first position from the second position.

In one embodiment, before the step of controlling, by the control module, the drive motor to drive the moving module to cause the self-moving device to turn: the control module controls the drive motor to drive the moving module to cause the self-moving device to withdraw for a preset distance at first.

In one embodiment, controlling, by the control module, the drive motor to drive the moving module to cause the self-moving device to turn is that: the drive motor causes the grounding parts of the track on both sides of the housing to realize differential motion, to further drive the self-moving device to turn.

In one embodiment, the turning instruction or turning information is any one of the following: the turning instruction from the outside, the distance information, reaching the predetermined standard, of the self-moving device and the border, the touch information of the self-moving device and the border, the relative position information of the self-moving device and the border, or the information triggered by a turning trigger switch disposed in the control module.

In one embodiment, the self-moving device comprises a support structure, mounted in the housing; and the control method for a self-moving device comprises the steps: controlling the support structure to extend out from the bottom of the housing before the self-moving device is controlled to turn, such that at least part of the track is supported away from a working plane; and controlling the support structure to withdraw into the housing after the self-moving device is controlled to finish the turning.

In one embodiment, when the support structure extends out from the bottom of the housing, the housing is controlled to rotate around the support structure, to cause the self-moving device to turn.

### BRIEF DESCRIPTION OF THE DRAWINGS

FIG. 1 is a structural schematic diagram of a self-moving device according to a first embodiment of the present invention.

FIG. 2 is a schematic diagram when the self-moving device as shown in FIG. 1 moves straightly.

FIG. 3 is a schematic diagram when the self-moving device as shown in FIG. 1 turns.

FIG. 4 is a schematic diagram of a control module of the self-moving device as shown in FIG. 1.

FIG. 5 is a schematic diagram of pressure during grounding of a track between a thrust wheel and a front wheel or a back wheel when the self-moving device as shown in FIG. 1 turns.

FIG. 6 is a schematic diagram when a self-moving device moves straightly according to a second embodiment of the present invention.

FIG. 7 is a schematic diagram when the self-moving device as shown in FIG. 6 turns.

FIG. 8 is a flow schematic diagram of a control method for the self-moving device according to the first embodiment of the present invention.

FIG. 9 is a schematic diagram when a self-moving device moves straightly according to a third embodiment of the present invention.

FIG. 10 is a schematic diagram when the self-moving device as shown in FIG. 9 turns.

FIG. 11 is a schematic diagram when a self-moving device turns according to a fourth embodiment of the present invention.

### DETAILED DESCRIPTION

In order to conveniently understand the present invention, the present invention will be described more comprehensively with reference to related drawings. The drawings give preferred embodiments of the present invention. However, the present invention can be implemented by many different forms, and is not limited to the embodiments described in the text. On the contrary, these embodiments are provided to make the disclosed content of the present invention clearer and more comprehensive to understand.

It should be noted that when the element is called to be “fixed” on the other element, it can be directly on the other element or another element can exist between the two elements. When one element is considered to be “connected” to the other element, it can be directly connected to the other element or another element possibly exists between the two elements.

Unless otherwise defined, all technical and scientific terms used in the text are same as those generally understood by those skilled in the art of the present invention. The terms used in the description of the present invention are merely intended for describing the specific embodiments rather than limiting the present invention. The term “and/or” used in the text comprises any and all combination of one or more related listed objects.

Firstly, it should be noted that a track type self-moving device is adaptive to severe environments and is thus widely applied to heavy machinery such as an excavator, a crane and a tank, and is also suitable for a mower to adapt to fluctuated lawns. For the heavy machinery such as the excavator, the crane and the tank, due to the larger load, in order to ensure the stability of the machinery, a grounding length is increased as much as possible generally, and there is no correlated research on the requirements on the track type self-moving device in the power tools with a small load, such as the mower, in the industry yet.

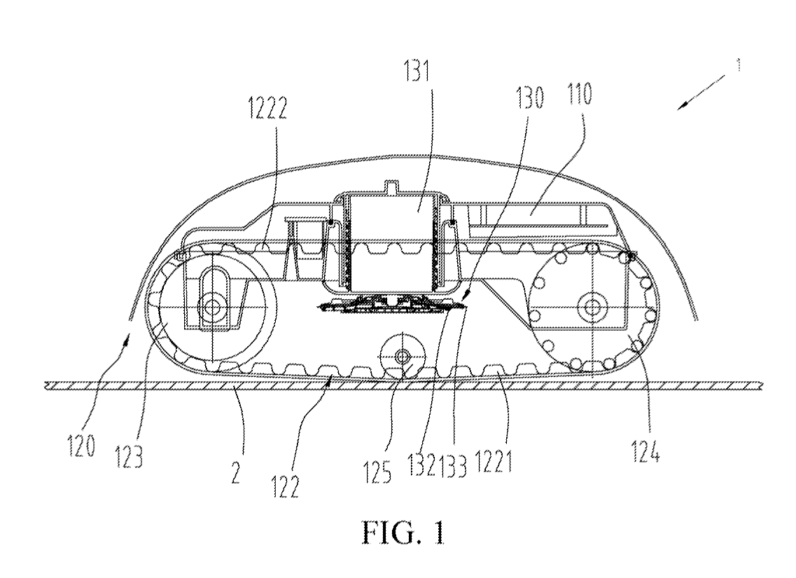

Referring to FIG. 1, in a first embodiment of the present invention, the self-moving device is an autonomous mower 1, and in other embodiments, the self-moving device can also be the device suitable for unattended operation, such as an automatic dust collector and an automatic snow blower. In the present embodiment, the autonomous mower 1 comprises a housing 110, a moving module 120 and a cutting module 130. The moving module 120 and the cutting module 130 are mounted on the housing 110.

The housing 110 has a front end and a back end. As shown in FIG. 1, the left side is the front side of the housing 110, and the right side is the back end. When the autonomous mower 1 advances, the advancing direction is consistent with the direction from the back end to the front end, i.e., the direction from right to left in FIG. 1.

The moving module 120 comprises a wheel set, the wheel set comprises a front wheel 123 and a back wheel 124, wherein the front wheel 123 is a guide wheel and the back wheel 124 is a drive wheel; a track 122, winding the wheel set and mounted on both sides of the housing 110; and a drive motor (also called as a walking motor in the following), driving the moving module 120 to drive the autonomous mower 1 to move.

When the drive motor drives the drive wheel to work, the track 122 is caused to drive the autonomous mower 1 to advance while performing rotational motion. The turning of the autonomous mower 1 is also realized by the driving of the drive motor for the drive wheel. There are at least two following manners:

Manner I, a pair of drive motors is disposed. The track 122 on both sides of the housing 110 is respectively driven by independent drive motors. When the turning is required, the two drive motors output different rotary speeds, such that the track 122 on both sides of the housing 110 realizes differential motion, and further the turning of the autonomous mower 1 is realized.

Manner II, only one drive motor is disposed. A differential mechanism is used to cause the track 122 on both sides of the housing 110 to realize the differential motion, and further the turning of the autonomous mower 1 is realized.

In the present embodiment, the drive motor is a drive motor.

The cutting module 130 comprises a cutting desk 132 and cutting blades 133, which are driven by the cutting motor 131 to execute the cutting operation. The cutting desk 133 rotates around a central axis per se. The cutting desk 132 is provided with the plurality of cutting blades 133 in the circumferential direction. The cutting motor 131 is a cutting motor.

In the present embodiment, the autonomous mower 1 further comprises a control module (not shown) and an adjusting device 80. The control module controls the moving module 120 to drive the autonomous mower 1 to move, and controls the cutting module 130 to execute the cutting operation. The control module is further configured to control the adjusting device 80 to adjust a grounding length of the track 122, such that the grounding length of the track 122 when the autonomous mower 1 turns is smaller than that of the track 122 when the autonomous mower 1 moves straightly.

In the present embodiment, since the grounding length of the track 122 when the autonomous mower 1 turns is smaller, the contact area between the track 122 and the lawn is smaller, the damage of the track 122 to the lawn is reduced, a minimal turning radius of the autonomous mower 1 can be reduced, and the trafficability of the machine is improved. Meanwhile, according to the formula, the turning resisting moment of the track is

$${M}_{μ} = \frac{μ GL}{4} ,$$

wherein μ is a turning resistance coefficient, G is the gravity of the machine, L is the grounding length of the track, it can be seen that the smaller the grounding length of the track is, the smaller the turning resisting moment is, and correspondingly, the smaller the output power of the drive motor of the autonomous mower 1 is. Therefore, the drive force of the drive motor can be reduced by reducing the grounding length of the track.

In the present embodiment, when the autonomous mower 1 moves straightly, the control module controls the grounding length of the track 122 to be larger than or equal to 300 mm. When the grounding length of the track 122 is set to be 300 mm when the autonomous mower 1 moves straightly, it can be ensured that the autonomous mower 1 has better climbing capacity and obstacle crossing capacity, etc. It is understandable that when the autonomous mower 1 moves straightly, the grounding length of the track 122 can be 300 mm, 350 mm, 400 mm, 450 mm, 500 mm, etc., and can be set according to actual needs.

In the present embodiment, when the autonomous mower 1 turns, the control module controls the grounding length of the track 122 to be smaller 300 mm. When the grounding length of the track 122 is smaller than 300 mm when the autonomous mower 1 turns, it is favorable for the drive motor to drive the autonomous mower 1 to turn. Meanwhile, a turning radius is controlled within 0.5 m. It is understandable that when the autonomous mower 1 turns, the grounding length of the track 122 controlled by the control module can be 250 mm, 200 mm, 150 mm, 100 mm and the like.

In the present embodiment, the turning radius when the control module controls the moving module 120 to drive the autonomous mower 1 to turn is smaller than or equal to 0.5 m. Specifically, the turning radius when the control module controls the moving module 120 to drive the autonomous mower 1 to turn can be zero.

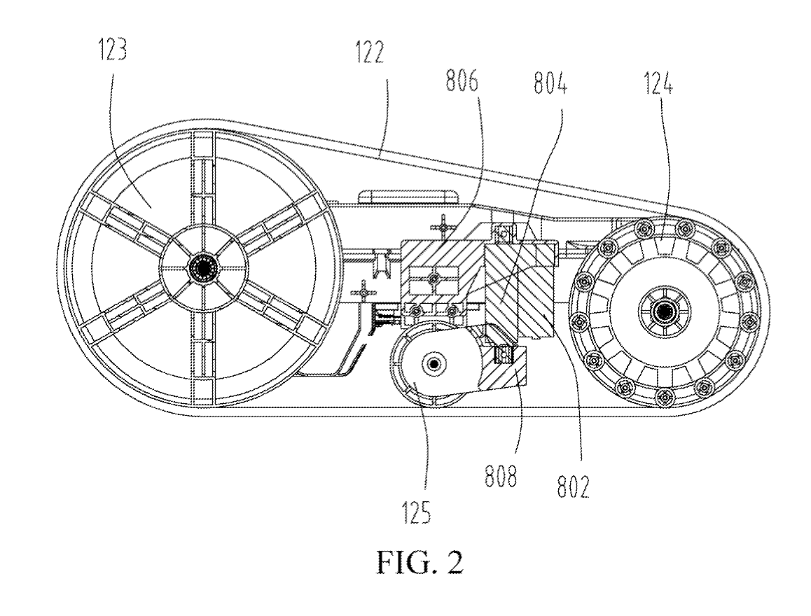

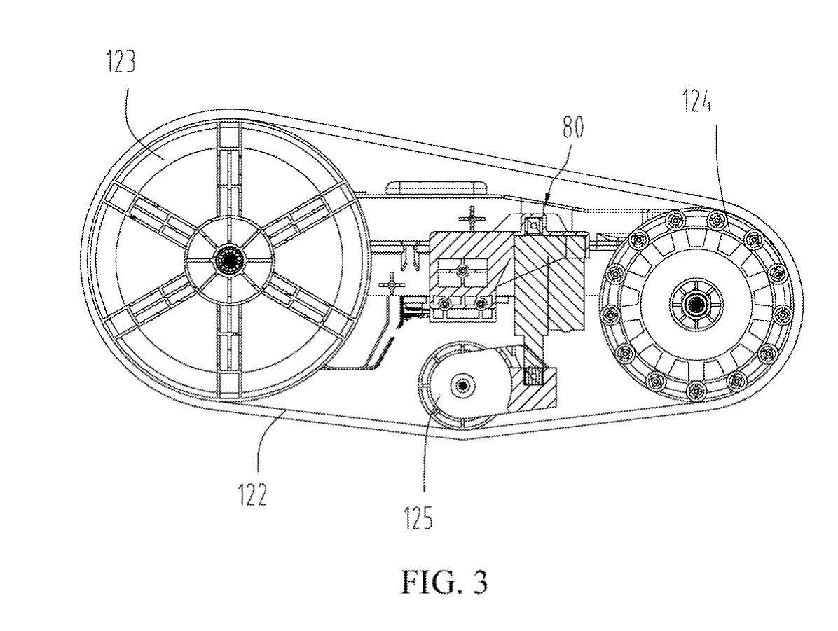

Referring to FIGS. 1 to 3, in the present embodiment, the adjusting device 80 comprises a thrust wheel 125, the thrust wheel 125 is located between the front wheel 123 and the back wheel 124, and the track 122 coats the thrust wheel 125. Specifically, in the present embodiment, it is understandable that the adjusting device 80 can comprise one, two or more than two thrust wheels 125.

In the present embodiment, when the autonomous mower 1 turns, the grounding length of the track 122 is smaller than or equal to a distance between the thrust wheel 125 and the front wheel 123, or is smaller than or equal to a distance between the thrust wheel 125 and the back wheel 124. Specifically, when there is only one thrust wheel 125, the track 122 between the thrust wheel 125 and the back wheel 124 or the track 122 between the thrust wheel 125 and the front heel 302 is grounded. When there are two thrust wheels 125, the track 122 between the two thrust wheels 125 is grounded, that is to say, the grounding length of the track of the autonomous mower 1 is smaller than the distance between the front wheel 123 and the back wheel 124.

In the present embodiment, when the autonomous mower 1 straightly moves, the grounding length of the track 122 is the distance between the front wheel 123 and the back wheel 124 in a horizontal direction.

In the present embodiment, the adjusting device 80 further comprises a lifting mechanism, connected to the thrust wheel 125, the lifting mechanism can drive the thrust wheel 125 to descend, to reduce the grounding length of the track 122; and the lifting mechanism can drive the thrust wheel 125 to ascend, to increase the grounding length of the track 122. Specifically, the track 122 comprises a grounding side 1221 and a remote side 1222 opposite to the grounding side 1221. The thrust wheel 125 can move between the grounding side 1221 and the remote side 1222, such that the autonomous mower 1 can be in a turning mode and a straight moving mode respectively. It should be noted that the grounding side 1221 of the track 122 is one side close to the ground 2, and is the part between the back wheel 124 and the front wheel 123 and coating the thrust wheel 125 in the present embodiment.

When the autonomous mower 1 turns, the grounding length of the track of the autonomous mower 1 is smaller than the distance between the front wheel 123 and the back wheel 124, that is to say, one side of the thrust wheel 125 close to the grounding side 1221 and the front wheel 123 and the back wheel 124 are respectively located on both sides of a common tangent of one side of the front wheel 123 and the back wheel 124 close to the grounding side 1221. When the autonomous mower 1 moves straightly, the track 122 between the back wheel 124 and the front wheel 123 is grounded, that is to say, the grounding length of the track 122 of the autonomous mower 1 is equal to the distance between the front wheel 123 and the back wheel 124, that is, the tangent of the thrust wheel 125 close to one side of the grounding side 1221 is coincided with the common tangent of one side of the front wheel 123 and the back wheel 124 close to the grounding side 1221.

In the present embodiment, the lifting mechanism of the autonomous mower 1 comprises a lifting drive part 802, a push rod 804 and a push rod support 806 which are connected to the housing 110, and a thrust wheel support 808 supporting the thrust wheel 125, one part of the push rod 804 is connected to the push rod support 806, the other part can be driven by the lifting drive part 802 to extend and withdraw, and the thrust wheel support 808 is connected on one telescopic end of the push rod 804, so as to drive the thrust wheel 125 to move and lift by driving of the lifting drive part 802. Specifically, the lifting drive part 802 can be a motor. The lifting mechanism further comprises a transmission mechanism connected between the lifting driver part 802 and the push rod 804, the transmission mechanism comprises a worm gear connected to the lifting drive part and a worm connected between the worm gear and the push rod 804, and the worm and the worm gear are meshed, so that the thrust wheel 125 can perform linear motion under rotation of the lifting drive part. It is understandable that the transmission mechanism can also be other structures such as a screw nut structure.

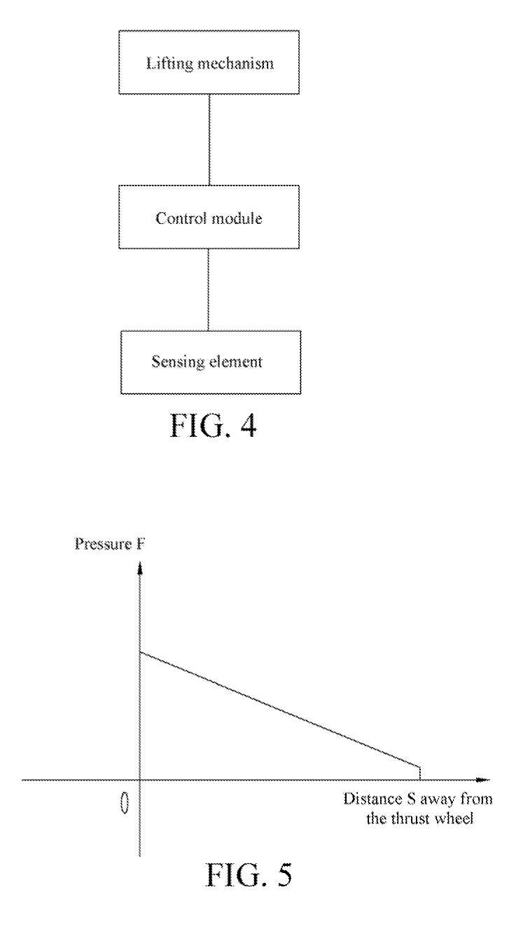

In the present embodiment, referring to FIG. 4, the adjusting device 80 further comprises a sensing element, configured to sense whether the state of the autonomous mower 1 needs to be changed, and the control module is configured to control the lifting drive part 802 according to the state sensed by the sensing element, so as to control the position of the thrust wheel 125. Specifically, the sensing element comprises a border detection sensor, the border detection sensor comprises an obstacle sensing sensor, when the sensing element senses the boundary or an obstacle, the autonomous mower 1 needs to turn, the control module can control the lifting drive part 802 to start according to the state sensed by the sensing element, and controls the thrust wheel 125 to move to a direction away from the remote side 1222 of the track 122, to reduce grounding length of the track 122 of the autonomous mower 1. After the turning is finished, the control module controls the lifting drive part 802 to rotate in an opposite direction, to control the thrust wheel 125 to move to a direction close to the remote side 1222 of the track 122, to increase the grounding length of the track 122 of the autonomous mower 1. In this way, the autonomous mower 1 can properly change the grounding length according to the actual condition of a walking environment, thereby not only ensuring the stability during normal walking, but also ensuring no damage to the lawn during turning and better trafficability, and greatly meeting the requirements of a user. It is understandable that the adjusting device 80 can also automatically turn according to other actual needs and can turn without depending on the sensing of the sensing element.

In the present embodiment, a distance between the center of gravity of the autonomous mower 1 and the center of the thrust wheel 125 along a moving direction of the autonomous mower 1 is smaller than or equal to 100 mm, such that the distance from a vertical straight line of the center of gravity of the autonomous mower 1 to the vertical straight line of the center of the thrust wheel 125 is within a smaller range. In this way, it is favorable for keeping the machine balanced as much as possible when only the thrust wheel 125 is grounded during the turning state of the autonomous mower 1, the grounding linear contact state of the thrust wheel 125 is kept as much as possible, even if not in the above linear contact state, the pressure of the autonomous mower 1 on the track can still be concentrated on the thrust wheel, and the pressure from the thrust wheel to the front wheel (or the back wheel) is gradually reduced. Therefore, the abrasion to the grass is still smaller. In another embodiment, the distance between the center of gravity of the autonomous mower 1 and the center of the thrust wheel 125 along a moving direction of the autonomous mower 1 is 0. In order to keep the autonomous mower 1 to be in linear contact with the ground during turning as much as possible, preferably, the vertical straight line of the center of gravity of the autonomous mower 1 is coincided with the vertical straight line of the center of the thrust wheel 125. Specifically, the coincidence between the vertical straight line of the center of gravity of the autonomous mower 1 and the vertical straight line of the center of the thrust wheel 125 comprises two cases: one case is that the center of gravity of the autonomous mower 1 is coincided with the thrust wheel 125; and the other case is that the thrust wheel 125 is located on the vertical straight line of the center of gravity of the autonomous mower 1. The above vertical straight line refers to a direction vertical to the horizontal plane.

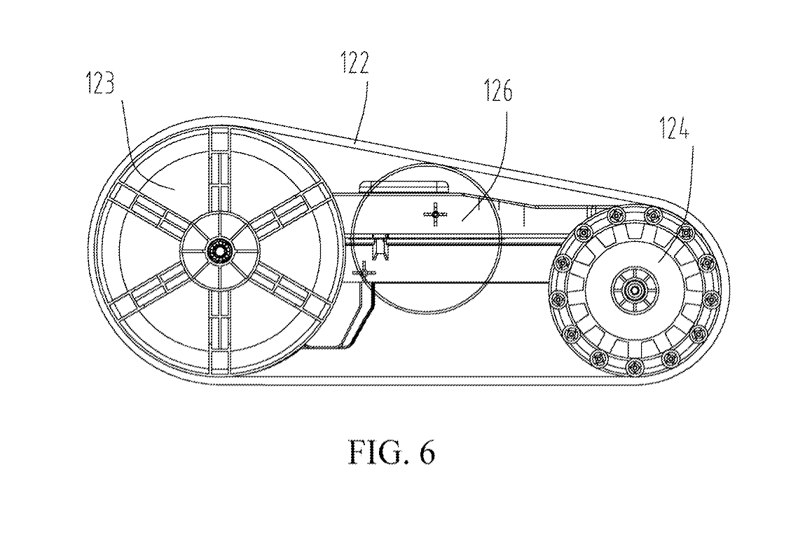

When the autonomous mower 1 turns, two cases may exist, the first case is to reduce the damage to the lawn to the most ideal state, that is, only the track 122 on the thrust wheel 125 is grounded, i.e., the track 122 and the ground are in linear contact, at this point, the contact area is minimal, the damage to the lawn is minimal, and the turning radius of the autonomous mower 1 can be zero, and the autonomous mower basically turns on site. The second case is that when there is only one thrust wheel 125, the track 122 on one side of the grounding side 1221 between the thrust wheel 125 and the back wheel 124 is grounded or the track 122 on one side of the grounding side 1221 between the thrust wheel 125 and the front wheel 302 is grounded, when there are two thrust wheels 125, the track 122 on one side of the grounding side 122 between the two thrust wheels 125 is grounded, that is to say, the grounding length of the track of the autonomous mower 1 is smaller than the distance between the front wheel 302 and the back wheel 304. The grass abrading degree is decided by slippage of the track, the larger the slippage is, the more severe the grass abrading is, while the slippage is in direct proportion to the grounding length of the track, and is in inverse proportion to the turning radius of the autonomous mower. Therefore, when the grounding length is long, the turning radius of the autonomous mower needs to be controlled to be larger than a preset value. In the above first case, the linear contact during turning is instable, the autonomous mower is dumped forward possibly, i.e., the first case is converted to the second case, although the front wheel is grounded, the center of gravity of the autonomous mower and the vertical straight line of the center of the thrust wheel are coincided or separated by a smaller distance, the pressure is concentrated in the position of the thrust wheel or nearby the thrust wheel, the pressure from the thrust wheel to the front wheel is gradually reduced, therefore, the grass abrading degree is still smaller and is much smaller than that of the case that the pressure is averagely distributed between the front wheel and the thrust wheel. The case that the autonomous mower is dumped backward is the same, and the specific pressure distribution refers to FIG. 5.

In the present embodiment, the back wheel 124 and the front wheel 123 of the autonomous mower 1 can be respectively rotatably connected on two opposite ends of the housing 110.

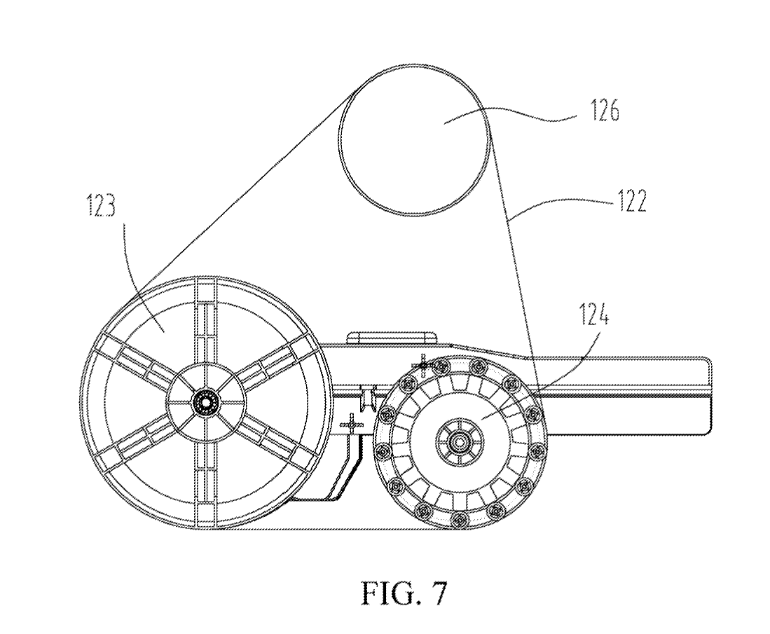

Referring to FIGS. 6 and 7, in a second embodiment of the present invention, the grounding length of the track 122 is the distance between the front wheel 123 and the back wheel 124 in the horizontal direction, the adjusting device 80 comprises a horizontal adjusting mechanism, adjusting the distance between the front wheel 123 and the back wheel 124 in the horizontal direction.

In the present embodiment, the adjusting device 80 further comprises a support wheel 126, the support wheel 126 is located between the front wheel 123 and the back wheel 124, when the autonomous mower 1 turns, the distance between the front wheel 123 and the back wheel 124 is smaller (as shown in FIG. 7)a, and when the autonomous mower 1 moves straightly, the distance between the front wheel 123 and the back wheel 124 is larger (as shown in FIG. 6).

In the present embodiment, the back wheel 124 can be horizontally and movably disposed relative to the front wheel 123, and the horizontal adjusting mechanism is connected to the support wheels 126 and can drive the support wheel 126 to move up and down, to drive the back wheel 124 to move horizontally, thereby adjusting the distance between the front wheel 123 and the back wheel 124 in the horizontal direction. It is understandable that the front wheel 302 can also be disposed in a horizontally moving manner.

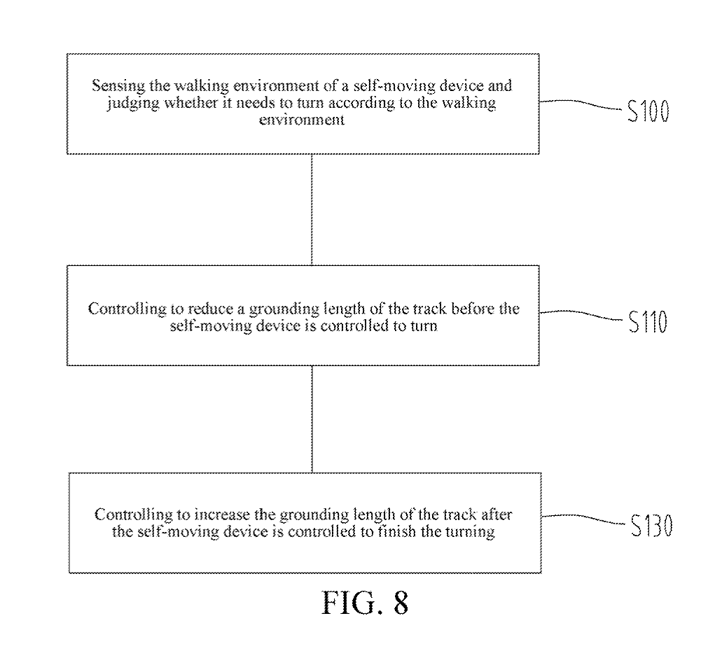

Referring to FIG. 8, a control method for the autonomous mower 1 is provided, which comprises the following steps:

S110: controlling to reduce a grounding length of the track 122 before the autonomous mower 1 is controlled to turn; and

S130: controlling to increase a grounding length of the track 122 after the autonomous mower 1 is controlled to finish the turning.

In one embodiment, the autonomous mower 1 comprises a thrust wheel 125, and the thrust wheel 125 is located between the front wheel 123 and the back wheel 124; the control method for the autonomous mower 1 comprises the following steps:

controlling the thrust wheel 125 to descend to reduce the grounding length of the track 122 before the autonomous mower 1 is controlled to turn; and

controlling the thrust wheel 125 to ascend to increase the grounding length of the track 122 after the autonomous mower 1 is controlled to finish the turning.

In another embodiment, the grounding length of the track 122 is the distance between the front wheel 123 and the back wheel 124 in a horizontal direction; the control method for the autonomous mower 1 comprises the steps:

controlling to reduce the distance between the front wheel 123 and the back wheel 124 in the horizontal direction before the autonomous mower 1 is controlled to turn; and

controlling to increase the distance between the front wheel 123 and the back wheel 124 in the horizontal direction after the autonomous mower 1 is controlled to finish the turning.

In the present embodiment, the control method for the autonomous mower 1 further comprises the step before the step S110:

sensing a walking environment of the autonomous mower 1 and judging whether the turning is required according to the walking environment.

In the present embodiment, the step S100 of sensing a walking environment of the autonomous mower 1 and judging whether the turning is required according to the walking environment specifically comprises: sensing whether there is an obstacle, and determining the turning is required if the obstacle is sensed, and determining no turning is required if no obstacle is sensed.

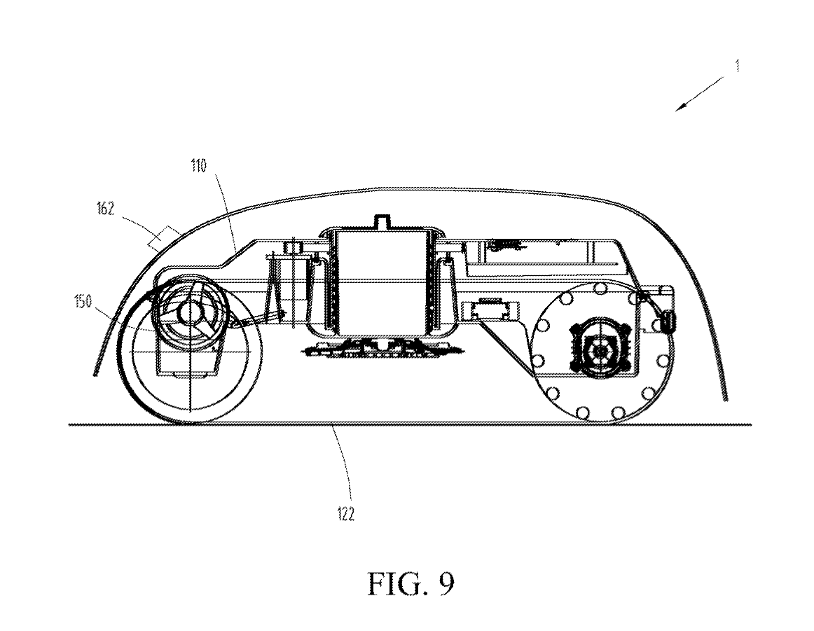

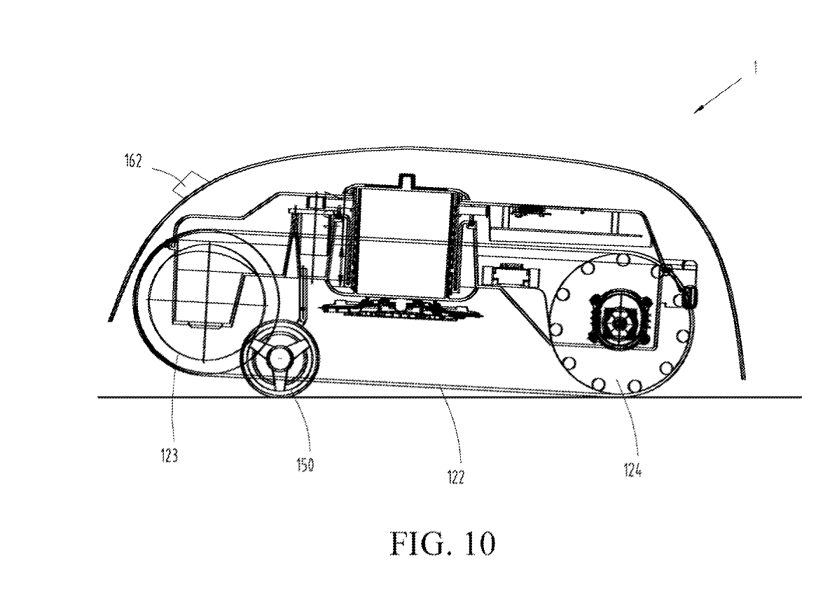

Referring to FIGS. 9 and 10, in a third embodiment of the present invention, the autonomous mower 1 comprises a turning wheel 150, assembled on the bottom of the housing 110. The turning wheel 150 can be liftably mounted on the bottom of the housing 110. Under the control of the control module, the turning wheel 150 has a first position as shown in FIG. 9 and a second position as shown in FIG. 10 in a height direction of the housing 110. In the first position, the bottom of the turning wheel 150 is higher than the bottom of the track 122, and the normal walking of the track 122 is not affected. In the second position, compared with the first position, the turning wheel 150 is descended relative to the housing 110, and the bottom of the turning wheel 150 is lower than the bottom of the track 122, such that one end of the track 122 is lifted up and the other end of the track 122 is grounded. In other words, after being descended, the turning wheel 150 replaces one end of the track 122 to support the autonomous mower 1.

When the control module receives a turning instruction or turning information, the position of the turning wheel 150 is controlled and the power output of the motor is controlled to be sent to the track 122. Specifically, when the autonomous mower 1 needs to turn, the control module causes the turning wheel 150 to descend to the second position from the first position, meanwhile, the control module controls the drive motor to cause the grounding parts of the track 122 on both sides of the housing 110 to realize differential motion, and further the turning is realized. One end of the track 122 is lifted up, and the grounding area of the whole track 122 is small, so that when the differential motion of the track 122 drives the autonomous mower 1 to turn, the damage of the track 122 to the turf is smaller. After the turning is finished, the control module causes the turning wheel 150 to ascend to the first position from the second position, and continuous advancing for mowing is not affected.

When the drive wheel is disposed close to the back end of the housing 110, since the whole back part of the autonomous mower 1 is heavier relatively, the turning wheel 150 is eccentrically disposed on the bottom of the housing 110, and is usually disposed close to the front end of the housing 110. When the turning wheel 150 is descended to the second position, the turning wheel 150 lifts the front end of the housing 110 up. The lifting of the turning wheel 150 can be realized by using a hydraulic mechanism, or an electric rocker, or a gear mechanism, or a gear-rack mechanism, or a screw rod mechanism. However, the turning wheel 150 can also lift the back end of the housing 110 up.

In addition, no matter the position of the drive wheel is close to the front end or the back end of the housing 110, the grounding parts of the track 122 on both sides of the housing 110 can realize the differential motion.

The amount of the turning wheel 150 is one, and the turning wheel 150 is disposed in the middle position of the front end of the housing 110, so as to achieve better stability when replacing the track 122 to support the autonomous mower 1. The amount of the turning wheels 150 can also be more, for example, two, three or more, and the turning wheels and the track 122 on both sides of the housing 110 support the autonomous mower 1 together, so that the autonomous mower 1 has more than four support points, thereby ensuring better stability during turning. The multiple turning wheels 150 can be uniformly distributed along a straight line, and can also form triangular or circular supporting.

In the present embodiment, the turning wheel 150 is a universal wheel.

In the present embodiment, the autonomous mower 1 can automatically move to mow the grass within a working area defined by the border and can realize automatic turning according to the position of the border.

The border is the generic name of the boundary and the obstacle. The boundary is the periphery of the whole working area, and is usually connected end to end to close the working area, the boundary can be tangible or electronic, that is, the boundary can be formed by a wall, a fence, handrails and the like, or a virtual boundary signal, such as an electromagnetic signal or optical signal, is sent by a boundary signal generating device. The obstacle is the part or section, where walking cannot be realized, within the working area, such as a sofa and a bedside table indoor or a water pond or a flower stand outdoor, similarly, the obstacle can also be tangible or electronic, the tangible obstacle can be formed by the foregoing obstacle, and the electronic obstacle can be formed by a virtual obstacle signal sent by the boundary signal generating device. The virtual boundary signal and the virtual obstacle signal can be the same or different signals, and are selected by specific needs.

Referring to FIG. 9 or 10, the autonomous mower 1 comprises a border detection sensor 162, configured to monitor the position information between the autonomous mower 1 and the border. The control module controls the turning wheel 150 to be converted between the second position and the first position according to the position information received by the border detection sensor 162. When the control module judges that the turning is required, the turning wheel 150 is controlled to move to the second position from the first position, to assist the track 122 to support the housing 110, and further to assist to finish the turning.

The border detection sensor 162 is configured to detect a relative position relationship between the autonomous mower 1 and the border, which specifically comprises one or more of the distance, the angle and the directions inside and outside the border. The forming and principle of the border detection sensor 162 have many types, for example, an infrared type, an ultrasonic type, a collision detection type, a magnetic induction type, etc.

The border detection sensor 162 can be a distance sensor. When the distance sensor detects that the distance between the autonomous mower 1 and the border reaches a predetermined standard, the control module controls the turning wheel 150 to move to the second position from the first position, and controls the drive motor to cause the track 122 on both sides of the housing 110 to realize differential motion, so as to realize turning.

The border detection sensor 162 can also be a collision type detection switch. When the border detection sensor touches the border, and the control module controls the turning wheel 150 to move to the second position from the first position, and controls the drive motor to cause the track 122 on both sides of the housing 110 to realize differential motion, so as to realize turning.

When the border is an electronic boundary, the border detection sensor 162 can also be a pair of position sensors disposed on the housing 110. When the autonomous mower 1 works nearby the border, the control module judges whether each sensor is without or outside the border according to the signals of the position sensors, when any sensor is changed from being in the border to be outside the border, the control module can judge that the sensor has crossed the border, then the turning wheel 150 is controlled to move to the second position from the first position, and the drive motor is controlled to cause the track 122 on both sides of the housing 110 to realize the differential motion, thereby realizing turning.

In an embodiment, before the autonomous mower 1 turns, the control module firstly controls the drive motor to drive the moving module 120 to withdraw for certain distance, such that the autonomous mower 1 gets away from the border, thereby ensuring an enough turning space in the case of not touching the border. The drive motor may not withdraw, when the border detection sensor 162 is the distance sensor, a proper sensing distance can be set to ensure the enough turning space. The turning wheel 150 can be descended in the withdrawing process, to save the time for turning.

The autonomous mower 1 can also turn after receiving an outside turning instruction, and can turn anytime without depending on a detection result of the border detection sensor 162.

Specifically, the control module comprises a signal receiver receiving the outside turning instruction. The signal receiver can be a wireless or wired signal receiver, and receives the control instruction from the outside in a wireless or wired manner. After the signal receiver receives the turning instruction, the control module controls the turning wheel 150 to move to the second position from the first position, and controls the drive motor to cause the track 122 on both sides of the housing 110 to realize the differential motion, thereby realizing turning.

Of course, the above structure can also be applied to a manually controlled mower, for example, a ridding mower, the advancing and turning of the mower are completely actively controlled by an operator according to a mowing condition, and at this point, the mower is not required to be provided with the border detection sensor 162.

At this point, the signal receiver can be a trigger switch. When the turning is required, the operator presses the turning trigger switch, the control module causes the turning wheel 150 to move to the second position from the first position, such that the turning wheel 150 is grounded and then plays a role of auxiliary turning.

In the present embodiment, the control module comprises a controller, configured to control the lifting of the turning wheel 150, and meanwhile configured to control the turning of the mower according to turning information or the turning instruction.

In other embodiments, the control module can have many controllers, wherein the lifting of the turning wheel 150 is specially controlled by one controller, and meanwhile, the turning of the mower is specially controlled by another controller.

When there is a plurality of turning wheels 150, the controllers of the same amount can be disposed to respectively control respective turning wheels. Or one controller can be used to control all turning wheels. At this point, such controller can also control the turning of the mower, and of course, another controller can also be disposed to specially control the turning of the mower.

A turning method for the above track type mower is provided, which comprises the following steps:

S210: receiving the turning instruction or the turning information conforming to a preset standard, and controlling the turning wheel 150 to move to the second position from the first position by the control module, such that one end of the track 122 is lifted up, and the other is grounded.

In the step, the turning instruction or turning information is any one of the following: the turning instruction from the outside, the distance information when the self-moving device and the border reaches the predetermined standard, the touch information of the self-moving device and the border, the relative position information of the self-moving device and the border, or the information triggered by a turning trigger switch disposed in the control module.

When the mower is the autonomous mower 1, the turning information is automatically monitored and acquired in real time by the border detection sensor 162. When the mower is not an autonomous mower 1, the turning instruction is sent by operation and control of the operator.

S220, controlling the drive motor to drive the moving module 120 to cause the mower to turn by the control module.

Controlling the drive motor to drive the moving module 120 to cause the mower to turn by the control module comprises: causing grounding parts of the track 122 on both sides of the housing 110 to realize differential motion by the drive motor, and further driving the mower to turn.

In addition, before the turning, the control module firstly controls the drive motor to cause the moving module 120 to withdraw for certain distance, such that the autonomous mower 1 gets away from the border, thereby ensuring an enough turning space in the case of not touching the border.

After the turning is finished, the control module controls the turning wheel 150 to move to the first position from the second position, such that the turning wheel 150 does not affect the next normal walking of the track 122.

In conclusion, according to the autonomous mower 1 and the turning method therefor according to the present embodiment, the bottom of the housing 110 is provided with the turning wheel 150, the autonomous mower 1 controls the turning wheel 150 to descend when it needs to turn, lifts one end of the track 122 away from the ground, and uses auxiliary turning of the turning wheel 150 to finish the turning, and the grounding area of the track 122 during turning is reduced, thereby reducing the damage of the track 122 to the turf.

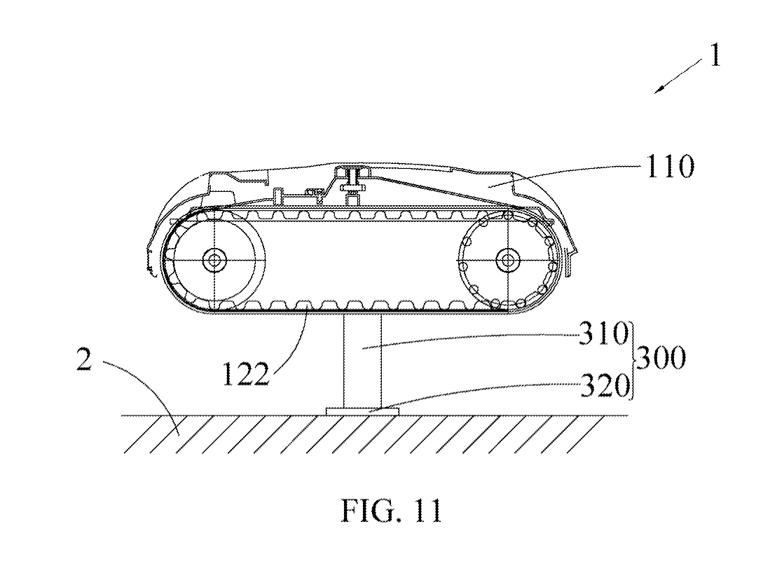

Referring to FIG. 11, in a fourth embodiment of the present invention, the autonomous mower 1 comprises a support structure 300, mounted in the housing 110. By the support structure 300, there is certain distance between the bottom of the housing 110 and the lawn. In this way, when the autonomous mower 1 turns, due to the above distance, the track 122 makes no contact with the lawn, and the abrasion to the lawn caused by the track 122 is avoided.

Meanwhile, the support structure 300 can extend out relative to the housing 110 or be withdrawn into the housing 110. In other words, the support structure 300 can perform telescopic motion. The support structure 300 works only when the autonomous mower 1 needs to turn, and at this point, the support structure 300 extends out of the housing 110. When the autonomous mower 1 needs no turning or after the turning is finished, the support structure 300 is withdrawn into the housing 110. In this way, the support structure 300 is prevented from generating interference to the trimming operation of the autonomous mower 1, the support structure 300 will not make contact with the lawn while the autonomous mower 1 is enabled to trim the lawn, stable operation of the autonomous mower 1 is ensured, the trimming effect of the autonomous mower 1 is ensured, and the use is convenient.

The support structure 300 can extend out from the bottom of the housing 110 relative to the housing 110, to support the track 122 or part of the track 122 away from the lawn. It should be noted that after the support structure 300 extends out from the bottom of the housing 110, the support structure 300 can support the track 122 away from the lawn. In this way, the autonomous mower 1 can turn to avoid the contact between the track 122 and the lawn. When the autonomous mower 1 turns, the housing 110 rotates around the support structure 300, and after the turning is finished, the support structure 300 is withdrawn into the housing 110. Specifically, before the autonomous mower 1 needs to turn, the support structure 300 extends out from the bottom of the housing 110, at this point, there is space between the bottom of the housing 110 and the lawn, such that the track 122 makes no contact with the lawn, and the damage of the track 122 to the lawn when the autonomous mower 1 turns is avoided. When the autonomous mower 1 is rotated to a required position, the support structure 300 is withdrawn into the housing 110, at this point, the autonomous mower 1 can continue to trim the lawn. The turning of the autonomous mower 1 is realized based only on the contact between the support structure 300 and the lawn, in this way, the contact between the track 122 and the lawn can be avoided, so that the damage of the track 122 to the lawn when the autonomous mower 1 turns is avoided. Of course, after the support structure 300 supports the track 122 away from the lawn, other operations except the turning can also be performed.

It should be noted that the rotary motion of the autonomous mower 1 is performed around the support structure 300, the support structure 300 will not be driven to rotate therewith, no friction is generated between the support structure 300 and the lawn, and the lawn is not damaged. Of course, the housing 110 can also drive the support structure 300 to rotate therewith, since the contact area between the support structure 300 and the lawn is obviously smaller than that between the track 122 and the lawn. Therefore, the damage to the lawn is small.

In the present embodiment, the control module and the support structure 300 are connected by a drive structure. The control module controls the drive structure to drive the support structure 300 to extend out or withdraw. When the autonomous mower 1 needs to turn, the control module controls the drive structure to drive the support structure 300 to extend out of the bottom of the housing 110, such that the support structure 300 supports the housing 110. After the turning of the autonomous mower 1 is finished, the control module controls the drive structure to drive the support structure 300 to withdraw into the housing 110.

The control module is further connected to a turning mechanism, and the control module controls the turning mechanism to drive the housing 110 to automatically rotate. The control module can control the turning mechanism to cause the housing 110 to rotate for a required angle. Besides, the turning mechanism can further ensure no interference between the turning of the housing 110 and the support structure 300, and ensures the turning stability of the housing 110. The turning mechanism comprises a bearing, mounted on the support structure 300. When the turning mechanism controls the housing 110 to rotate, the bearing can cause the support structure 300 to not be interfered with other parts of the turning mechanism, thereby ensuring the turning stability of the housing.

Further, the autonomous mower 1 further comprises a height sensor, and the height sensor is electrically connected to the control module. The control module can control the height sensor to detect the height of a trimmed object in the lawn, to control an extending length of the support structure 300. In the an embodiment, the control module can control the height sensor to detect an actual height of the grass on the lawn, the height sensor transmits an actual height signal of the grass to the control module, and then the control module controls the drive structure to drive the support structure 300 to extend for a required length, to avoid the contact between the track 122 and the lawn. Of course, in other embodiments of the present invention, the control module can also control the support structure 300 to extend for a fixed length, for example, the support structure 300 extends for the fixed length of 60 mm-80 mm, to achieve the purpose of avoiding the contact between the track 122 and the lawn.

Further, the extending length of the support structure 300 is larger than or equal to the height of the trimmed object. In other words, the extending length of the support structure 300 should be larger than or equal to the height of the grass on the lawn. After the support structure 300 extends out of the housing 110, the housing 110 can be supported, such that the distance between the track 122 and the lawn is larger than or equal to the height of the grass, in this way, when the housing 110 turns, the track 122 will not make contact with the grass in the lawn, and the damage to the lawn is further avoided.

Further, after the support structure 300 is withdrawn into the housing 110, the end part of the support structure 300 is flush with the bottom of the housing 110. That is to say, after the support structure 300 is withdrawn into the housing 110, the end part of the support structure 300 and the bottom of the housing 110 are in the same plane. In this way, when the autonomous mower 1 performs the trimming operation, the support structure 300 will not generate influence on the lawn. Meanwhile, the support structure 300 is not required to be withdrawn into the housing 110, the moving distance of the support structure 300 is reduced, and the efficiency is improved.

As an embodiment, the support structure 300 is located in the center of gravity of the autonomous mower 1. After the support structure 300 supports the housing 110 up, the support structure 300 will bear all weight of the autonomous mower 1. In order to avoid a deviated falling phenomenon when the housing 110 turns and ensure stable rotation of the autonomous mower 1, the support structure 300 should be located in the position of the center of gravity of the autonomous mower 1, thereby ensuring that the housing 100 can be kept balanced after the support structure 300 supports the housing 110.

As an embodiment, the support structure 300 comprises a support rod 310, and the control module can control the support rod 310 to extend out relative to the housing 110 or withdraw into the housing 110. In the present embodiment, the housing 110 is supported by the support rod 310, and the control module controls the support rod 310 to extend out or withdraw. Besides, a sectional shape of the support rod 310 can be polygonal, circular or oval.

Of course, the amount of the support rods can also be at least two, and the sectional sizes of the at least two support rods 310 are changed in sequence; the axes of the at least two support rods 310 are coincided and disposed by sleeving; and the control module controls the at least two support rods 310 to extend out in sequence or withdraw in sequence. In other words, the extending length of the support structure 300 is at least twice of the length of the support rods 310. In this way, the length range of the support rods 310 can be increased, such that the housing 110 according to embodiments of the present invention can be supported to any height.

When the amount of the support rods 310 is at least two, the sectional sizes of the support rods 310 are gradually increased, the support rod 310 with the maximal sectional size is located on the outermost side, and the support rod 310 with the minimal sectional size is located on the innermost side. The support rods 310 are arranged from outside to inside according to the sectional sizes of the support rods 310 from large to small.

Further, the support structure 300 further comprises a support chassis 320, and the chassis 320 is disposed on one end of the support rod 310 away from the housing 110. The support rod 310 makes contact with the lawn by the chassis 320. After the support structure 300 supports the housing 110, the support structure 300 bears all weight of the autonomous mower 1. If only the support rod 310 supports the housing 110, one end of the support rod 310 away from the housing 110 may be sunken into the lawn and the lawn is easy to damage. The chassis 320 can increase the contact area between the support rod 310 and the lawn, concentration of the weight of the housing 110 is avoided, the support effect of the support structure 300 is ensured, the support structure 300 is prevented from being sunken into the lawn and the damage to the lawn is avoided.

Further, the sectional area of the chassis 320 is 1.2-5 times of the sectional area of the support rod 310. The contact area between the support structure 300 and the lawn is increased by the chassis 320, thereby being convenient for the support structure 300 to support the housing 110. If the sectional area of the chassis 320 is too small, the support effect of the chassis 320 is nearly same as that of the support rod 310. If the sectional area of the chassis 320 is too large, the trimming operation of the housing 110 is affected, and meanwhile, the size of the housing 110 is also increased. The height of the chassis 320 is 0.15-0.6 times of the sectional area of the support rod 310, so as to be convenient for the support structure 300 to extend out and withdraw.

Besides, the chassis 320 can also be a hollowed structure, i.e., there is a hollow where the chassis 320 and the lawn contacts. That is to say, the contact area between the chassis 320 and the lawn is smaller than the area of the chassis 320. In this way, the contact area between the chassis 320 and the lawn can be reduced, the damage to the lawn is avoided, and the influence on the lawn is reduced.

As an embodiment, the support structure 300 is a cylinder, the cylinder comprises a cylinder block and a telescopic rod extending out or withdrawing relative to the cylinder block. The cylinder block is mounted in the housing 110 and the telescopic rod can extend out or withdraw relative to the housing 110. The housing 110 can also be supported by the cylinder, it is convenient for the turning operation of the housing 110, and further the abrasion to the lawn is avoided.

The drive structure can be a gear transmission structure and can also be a pump. When the support structure 300 is the support rod 310, the support structure 300 can be driven by a gear transmission structure and the like to extend out and withdraw. When the support structure 300 is the cylinder, the telescopic rod can be driven by the pump to extend out and withdraw. Of course, the drive structure can also be other structures capable of driving the support structure 300 to extend out and withdraw.

The autonomous mower 1 according to embodiments of the present invention can also be other types of mowers except the track type mower, the mower is prevented from making contact with the lawn when it turns, the damage to the lawn is further avoided, and the use is convenient. In embodiments of the present invention, the autonomous mower 1 is a track type mower preferably.

The foregoing embodiments merely express several embodiments of the present invention, the description is relatively specific and detailed, but cannot be understood as a limitation to the scope of the present invention patent. It should be pointed out that those ordinary skilled in the art can make several transformations and improvements without departing from the concept of the present invention, which all belong to the protective scope of the present invention. Therefore, the protective scope of the present invention patent should take the appended claims as a criterion.

| | | |
|---|---|---|
| 1 Autonomous mower | 2 Ground | 110 Housing |
| 120 Moving module | 122 Track | 123 Front wheel |
| 124 Back wheel | 125 Thrust wheel | 126 Support wheel |
| 1221 Track grounding | 1222 Track remote side | 130 Cutting |
| side | | mechanism |
| 131 Cutting motor | 132 Cutting desk | 133 Cutting blade |
| 150 Turning wheel | 162 Border detection | 80 Adjusting device |
| | sensor | |
| 802 Lifting drive part | 804 Push rod | 806 Push rod support |
| 808 Thrust wheel | 300 Support structure | 310 Support rod |
| support | | |

320 Chassis

What is claimed is:

1. A self-moving device, comprising:
a housing; and
a moving module, mounted in the housing, wherein the moving module comprises a track, driven by a drive motor to drive the self-moving device to move; the self-moving device is characterized in that the self-moving device further comprises a control module and an adjusting device, the control module controls the adjusting device to adjust a grounding length of the track, such that the grounding length of the track when the self-moving device turns is smaller than that of the track when the self-moving device moves straightly.

2. The self-moving device according to claim 1, wherein the control module controls the grounding length of the track to be larger than or equal to 300 mm when the self-moving device moves straightly, and optionally, wherein the control module controls the grounding length of the track to be smaller than 300 mm when the self-moving device turns.

3. The self-moving device according to claim 1, wherein a turning radius when the control module controls the moving module to drive the self-moving device to turn is smaller than or equal to 0.5 m, and optionally, wherein the turning radius when the control module controls the moving module to drive the self-moving device to turn is zero.

4. The self-moving device according to claim 1, wherein the moving module comprises a wheel set, the track winds the wheel set, the wheel set comprises a front wheel and a back wheel, and the grounding length of the track is the distance between the front wheel and the back wheel in a horizontal direction; and
the adjusting device comprises a horizontal adjusting mechanism, adjusting the distance between the front wheel and the back wheel in the horizontal direction.

5. The self-moving device according to claim 1, wherein the moving module comprises a wheel set, the track winds the wheel set, the wheel set comprises a front wheel and a back wheel, the adjusting device comprises a thrust wheel, and the thrust wheel is located between the front wheel and the back wheel.

6. The self-moving device according to claim 5, wherein the adjusting device comprises a lifting mechanism, connected to the thrust wheel, the lifting mechanism drives the thrust wheel to descend, to reduce the grounding length of the track; and the lifting mechanism drives the thrust wheel to ascend, to increase the grounding length of the track.

7. The self-moving device according to claim 6, wherein the control module controls the lifting mechanism to drive the thrust wheel to descend before controlling the self-moving device to turn; and the control module controls the lifting mechanism to drive the thrust wheel to ascend after controlling the self-moving device to finish the turning.

8. The self-moving device according to claim 5, wherein a distance between the center of gravity of the self-moving device and the center of the thrust wheel along a moving direction of the self-moving device is smaller than or equal to 100 mm, and optionally, wherein the distance between the center of gravity of the self-moving device and the center of the thrust wheel along the moving direction of the self-moving device is 0.

9. The self-moving device according to claim 1, wherein the self-moving device is an autonomous mower.

10. The self-moving device according to claim 1, wherein the adjusting device comprises a turning wheel, liftably assembled on the bottom of the housing, the turning wheel has a first position and a second position in a height direction of the housing, wherein in the first position, the bottom of the turning wheel is higher than the bottom of the track, and in the second position, one end of the track is lifted up relative to the other end of the track by the turning wheel; and
when the self-moving device turns, the control module controls the turning wheel to be in the second position, and when the self-moving device moves straightly, the control module controls the turning wheel to be in the first position.

11. The self-moving device according to claim 1, wherein the adjusting device comprises a support structure, mounted in the housing;
the control module controls the support structure to extend out from the bottom of the housing or withdraw into the housing;
before controlling the self-moving device to turn, the control module controls the support structure to extend out from the bottom of the housing, to support at least part of the track away from a working plane; and
if judging that the turning of the self-moving device is finished, the control module controls the support structure to withdraw into the housing.

12. The self-moving device according to claim 11, wherein the grounding length of the track is zero when the support structure extends out from the bottom of the housing, and optionally, wherein the self-moving device comprises a turning mechanism, rotatably connected to the housing and the support structure, when the support structure extends out from the bottom of the housing, the control module controls the turning mechanism to drive the housing to rotate around the support structure, to cause the self-moving device to turn.

13. A control method for a self-moving device, wherein the self-moving device comprises a housing; and a moving module, mounted in the housing; the moving module comprises a track, driven by a drive motor to drive the self-moving device to move; the control method is characterized in that the control method for a self-moving device comprises the steps:
controlling to reduce a grounding length of the track before the self-moving device is controlled to turn; and
controlling to increase a grounding length of the track after the self-moving device is controlled to finish the turning.

14. The control method for a self-moving device according to claim 13, wherein the self-moving device comprises a wheel set, the track winds the wheel set, the wheel set comprises a front wheel and a back wheel, the self-moving device further comprises a thrust wheel, and the thrust wheel is located between the front wheel and the back wheel; the control method for a self-moving device comprises the steps:
controlling the thrust wheel to descend to reduce a grounding length of the track before the self-moving device is controlled to turn; and
controlling the thrust wheel to ascend to increase a grounding length of the track after the self-moving device is controlled to finish the turning.

15. The control method for a self-moving device according to claim 13, wherein the self-moving device comprises a wheel set, the track winds the wheel set, the wheel set comprises a front wheel and a back wheel, and the grounding length of the track is the distance between the front wheel and the back wheel in a horizontal direction; the control method for a self-moving device comprises the steps:
controlling to reduce the distance between the front wheel and the back wheel in the horizontal direction before the self-moving device is controlled to turn; and
controlling to increase the distance between the front wheel and the back wheel in the horizontal direction after the self-moving device is controlled to finish the turning.

16. The control method for a self-moving device according to claim 13, wherein the self-moving device comprises a turning wheel, liftably assembled on the bottom of the housing; and the control method for a self-moving device comprises the steps:
controlling the turning wheel to descend to cause one end of the track to be lifted up relative to the other end of the track before the self-moving device is controlled to turn; and
controlling the turning wheel to ascend to cause the bottom of the turning wheel to be higher than the bottom of the track after the self-moving device is controlled to finish the turning.

17. The control method for a self-moving device according to claim 13, wherein the self-moving device comprises a support structure, mounted in the housing; and the control method for a self-moving device comprises the steps:
controlling the support structure to extend out from the bottom of the housing before the self-moving device is controlled to turn, to support at least part of the track away from a working plane; and
controlling the support structure to withdraw into the housing after the self-moving device is controlled to finish the turning.
